(19) United States
(12) Patent Application Publication
(10) Pub. No.: US 2007/0097935 A1
(43) Pub. Date: May 3, 2007

(54) In-band rate control for an orthogonal frequency division multiple access communication system

(76) Inventors: Alexei Gorokhov, San Diego, CA (US); Tingfang Ji, San Diego, CA (US); Aamod Khandekar, San Diego, CA (US); Avneesh Agrawal, Sa Diego, CA (US)

Correspondence Address: QUALCOMM INCORPORATED, 5775 MOREHOUSE DR., SAN DIEGO, CA, 92121, US

(21) Appl. No.: 11/369,466

(22) Filed: Mar. 7, 2006

Related U.S. Application Data
(60) Provisional application No. 60/731,028, filed on Oct. 27, 2005.
(60) Provisional application No. 60/731,037, filed on Oct. 27, 2005.

(51) Int. Cl. H04Q 7/24

(52) U.S. Cl. 370/338

(57) ABSTRACT

Systems and methods are disclosed that facilitate dynamic reverse link rate control by an access terminal and in-band signaling of changes of the reverse link rate by the access terminal.

### CROSS-REFERENCE TO RELATED APPLICATION

This application claims priority to U.S. Provisional Patent Application Ser. No. 60/731,028, entitled “Methods And Apparatus For Providing Mobile Wireless Lower MAC,” filed Oct. 27, 2005, and U.S. Provisional Application Ser. No. 60/731,037 entitled “METHODS For Providing Mobile Broadband Wireless Higher MAC” filed Oct. 27, 2005 which are incorporated herein by reference in their entirety.

### BACKGROUND

1. Field

The present disclosure relates generally to data communication, and more specifically to rate signaling for a communication system.

2. Background

A wireless multiple-access communication system can concurrently communicate with multiple terminals on the forward and reverse links. The forward link (or downlink) refers to the communication link from the base stations to the terminals, and the reverse link (or uplink) refers to the communication link from the terminals to the base stations. Multiple terminals may simultaneously transmit data on the reverse link and/or receive data on the forward link. This is often achieved by multiplexing the transmissions on each link to be orthogonal to one another in time, frequency and/or code domain.

The terminals may be distributed throughout the system and may experience different channel conditions (e.g., different fading, multipath, and interference effects). Consequently, these terminals may achieve different signal-to-noise-and-interference ratios (SINRs). The SINR of a traffic channel determines its transmission capability, which is typically quantified by a particular data rate that may be reliably transmitted on the traffic channel. If the SINR varies from terminal to terminal, then the supported data rate would also vary from terminal to terminal. Moreover, since the channel conditions typically vary with time, the supported data rates for the terminals would also vary with time.

Rate control is a major challenge in a multiple-access communication system. Rate control entails controlling the data rate of each terminal based on the channel conditions for the terminal. The goal of rate control should be to maximize the overall throughput while meeting certain quality objectives, which may be quantified by a target packet error rate (PER) and/or some other criterion.

There is therefore a need in the art for techniques to effectively perform rate control in a multiple-access communication system.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a method comprises determining, at an access terminal, a new rate for reverse link transmission, determining whether the new rate is different than a rate indicated by an access point for reverse link transmission, and if the new rate is different, transmitting a packet including an indicator of the rate.

According to another aspect, an access terminal comprises a processor configured to determine a new rate based at least in part upon channel conditions determined at the access terminal, determine whether the new rate is a same as a rate indicated by an access point, and to instruct including an indication of the new rate in a header of a packet transmitted, if the new rate is different from the rate indicated. There may also be a memory coupled to the processor.

According to yet another aspect, an apparatus can comprise means for determining, at an access terminal, a new rate for reverse link transmission, means for determining whether the new rate is different than a rate indicated by an access point for reverse link transmission, and means for, if the rate is different, transmitting a packet an indicator of the new rate.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 illustrates aspects of a multiple access wireless communication system.

FIG. 2A illustrates aspects of a method for communicating reverse link rate indications by an access terminal.

FIG. 2B illustrates aspects of an apparatus for communicating reverse link rate indications by an access terminal.

FIG. 3 illustrates aspects of a MAC packet.

FIG. 4 illustrates aspects of a receiver and transmitter in a wireless communication system.

FIG. 5 illustrates aspects of an access point.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. One or more components may reside within a process and/or thread of execution and a component may be localized on one computer and/or distributed between two or more computers. Also, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a subscriber station. A subscriber station can also be called a system, a subscriber unit, mobile station, mobile, remote station, access point, base station, remote terminal, access terminal, user terminal, user agent, user equipment, etc. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include, but are not limited to, magnetic storage devices (e.g., hard disk, floppy disk, magnetic strips . . . ), optical disks (e.g., compact disk (CD), digital versatile disk (DVD). . . ), smart cards, flash memory devices (e.g., card, stick, key drive . . . ), and integrated circuits such as read only memories, programmable read only memories, and electrically erasable programmable read only memories.

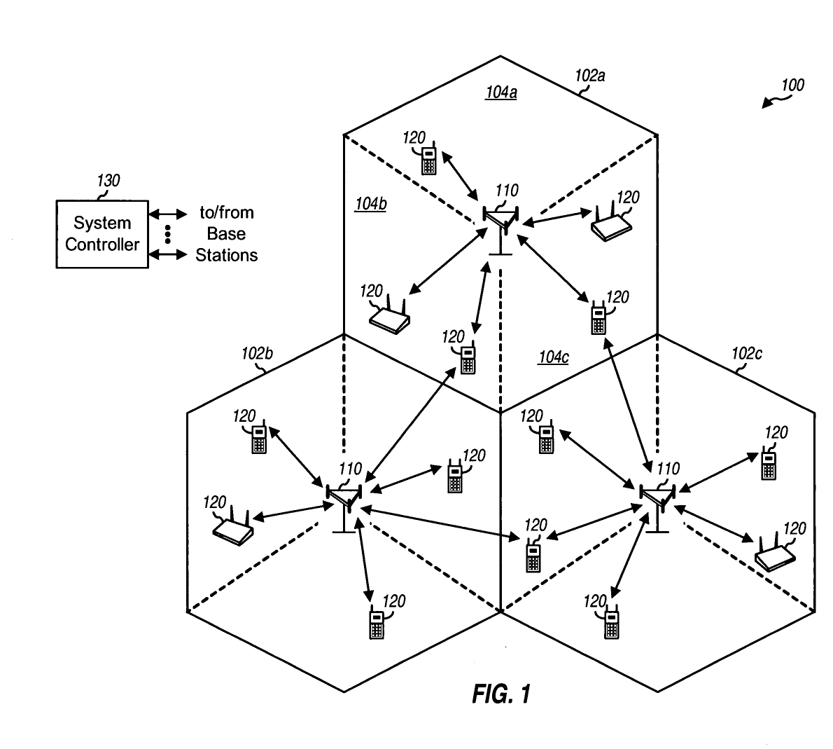

Referring to FIG. 1, a multiple access wireless communication system according to one embodiment is illustrated. A multiple access wireless communication system 1 includes multiple cells, e.g. cells 2, 104, and 106. In FIG. 1, each cell 2, 4, and 6 may include an access point that includes multiple sectors. The multiple sectors are formed by groups of antennas each responsible for communication with access terminals in a portion of the cell. In cell 2, antenna groups 12, 14, and 16 each correspond to a different sector. In cell 4, antenna groups 18, 20, and 22 each correspond to a different sector. In cell 6, antenna groups 24, 26, and 28 each correspond to a different sector.

Each cell includes several access terminals which are in communication with one or more sectors of each access point. For example, access terminals 30 and 32 are in communication with access point base 42, access terminals 34 and 36 are in communication with access point 44, and access terminals 38 and 40 are in communication with access point 46.

Controller 50 is coupled to each of the cells 2, 4, and 6. Controller 50 may contain one or more connections to multiple networks, e.g. the Internet, other packet based networks, or circuit switched voice networks that provide information to, and from, the access terminals in communication with the cells of the multiple access wireless communication system 1. The controller 50 includes, or is coupled with, a scheduler that schedules transmission from and to access terminals. In other embodiments, the scheduler may reside in each individual cell, each sector of a cell, or a combination thereof.

It should be noted that while FIG. 1, depicts physical sectors, i.e. having different antenna groups for different sectors, other approaches may be utilized. For example, utilizing multiple fixed “beams” that each cover different areas of the cell in frequency space may be utilized in lieu of, or in combination with physical sectors. Such an approach is depicted and disclosed in co-pending U.S. patent application Ser. No. 11/260,895, entitled “Adaptive Sectorization In Cellular System,” which is incorporated herein by reference.

Transmission on the reverse link, from the access terminals to the sectors or cells, may be multiplexed in time and frequency. The reverse link transmissions for a given access terminal may constitute contiguous subcarriers, contiguous OFDM symbols, blocks comprising resources corresponding to groups subcarriers and OFDM symbols, or individual symbols spread through out frame or transmission period. The assignments for these transmission, which in certain aspects, may be received via reverse link assignment blocks (R-LABs) received from the cell or sector. However, other assignment schemes may be utilized, e.g. unicast, broadcast, multicast, implicit, real time, token, etc.

Further, in some aspects the assignments may identify logical resources that map to physical resources. In some aspects, the logical resources may specified by a set of channel tree nodes and interlace(s). However, other assignment identifiers may be utilized. Additionally, the assignment may be “sticky” (e.g., an assignment persists over time rather than having a deterministic expiration time).

The rate, e.g. packet format, utilized for reverse link communication may be specified by the R-LAB or other rate control message. However, in some instances the access points channel measurements or rate decision may not be accurate. For example, the interference measurement may be inaccurate or may be based on information from outdated pilot or other channel information. Further, the buffer level at the access terminal may have increased or decreased, resulting in a change of the amount of data to be transmitted. Additionally, the sustainable power level, which may be a function of the peak power, available to the access terminal may have changed and thus the spectral efficiency possible may have changed.

In such cases, the access terminal may want to change rates for its reverse link transmissions. In order to do this, the access terminal may signal in-band its rate change in the same transmission as the data that it is modulating using the different rate, e.g. packet format. In some aspects, this may be in the header of the medium access control (MAC) layer packet it is transmitting.

In certain aspects, a packet format is provided along with a number of re-transmission attempts, if an acknowledgement is not received, and the packet format for both the initial and re-transmission attempts. An exemplary, indication of packet format in the format is shown below in Table 1.

TABLE 1
RL packet formats

| Packet | Spectral | Max number | Modulation order for each | | | | | |
|---|---|---|---|---|---|---|---|---|
| format | efficiency on 1^{st} | of | transmission | | | | | |
| index | transmission | transmissions | 1 | 2 | 3 | 4 | 5 | 6 |
| 0 | 1.0 | 6 | 2 | 2 | 2 | 2 | 2 | 2 |
| 1 | 1.5 | 6 | 3 | 2 | 2 | 2 | 2 | 2 |
| 2 | 2.0 | 6 | 3 | 3 | 2 | 2 | 2 | 2 |
| 3 | 2.67 | 6 | 4 | 4 | 3 | 3 | 3 | 3 |
| 4 | 4.0 | 6 | 4 | 4 | 3 | 3 | 3 | 3 |
| 5 | 6.0 | 6 | 4 | 4 | 4 | 3 | 3 | 3 |

A packet format index specifies the spectral efficiency, maximum number of transmissions, and the modulation format to be used for each transmission of a data packet. Each packet format may be indexed by a packet format index. The modulation format is specified by the number of bits in each modulation symbol, which is denoted by modulation order. Modulation orders of 2, 3, and 4 correspond to QPSK, 8PSK, and 16 QAM modulations, respectively.

The packet formats may be stored in a look-up table to allow the access terminal to determine its indication of rate by looking up the channel conditions, e.g. from which a determination as to the supportable spectral efficiency may be looked up or determined, versus the rate under such channel conditions.

It should be further noted that the packet format index, modulation order, number of re-transmissions, and spectral efficiency may vary, or not be included, in the rate decision and thus not be signified by an index or identifier.

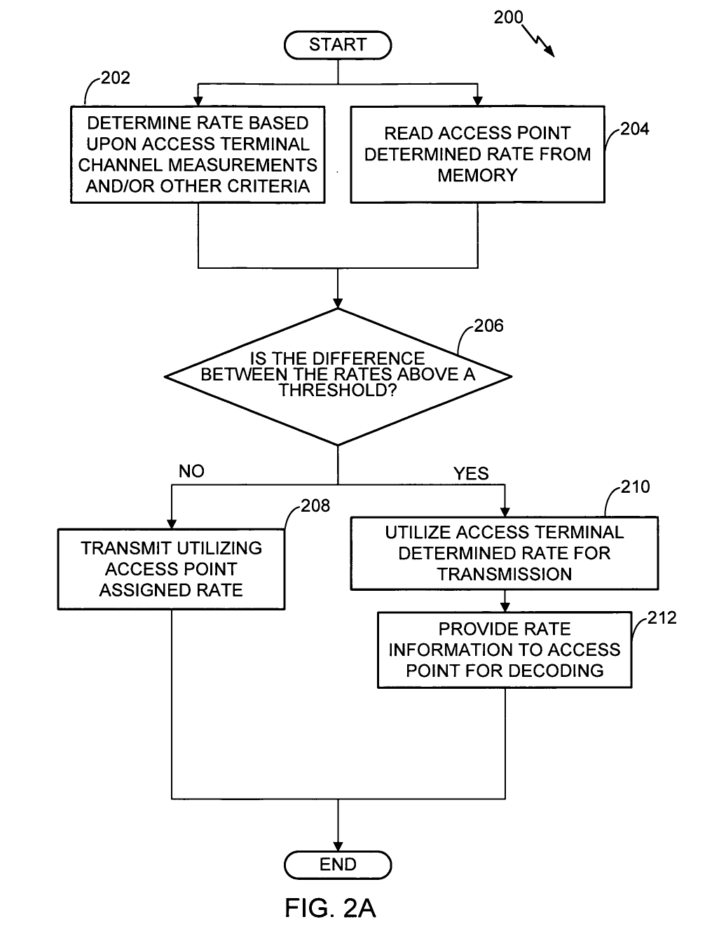

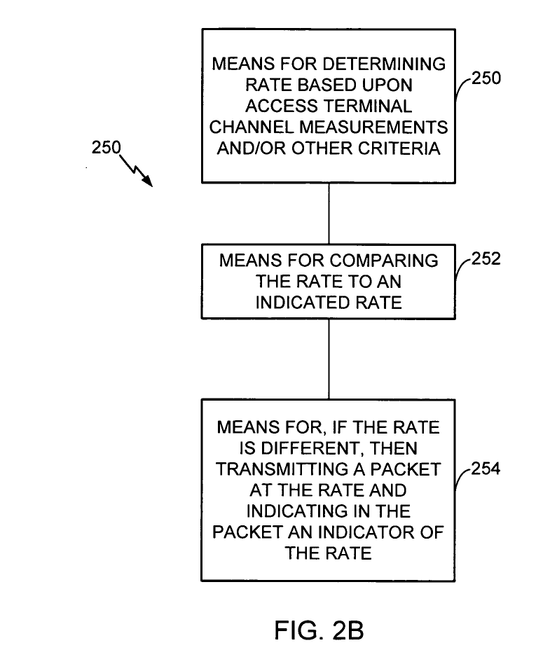

FIG. 2A illustrates aspects of a method 200 for communicating reverse link rate indications by an access terminal. A determination is made as to the rate for reverse link transmission, at the access terminal, based upon channel conditions, pilot signals, other criteria, or combinations thereof, block 202. The rate control algorithm utilized may be the same or different than the rate control algorithm utilized by the access point, to generate the rate provided in the R-LAB. Exemplary rate control algorithms are depicted and disclosed co-pending US patent application Publication No. 20030236080, entitled “Rate Control for Multi-Channel MIMO Systems;” US patent application Publication No. 20050088959, entitled “Rate Control for Multi-Channel Communication Systems;” and U.S. patent application Ser. No. 11/150,417, entitled “Rate Selection For A Quasi-Orthogonal Communication System;” each of which is incorporated herein in its entirety. Additionally, it should be noted that other-rate control algorithms for multi-user systems that utilize signal-to-noise ratios, carrier-to-interference ratios, interference statistics, maximum power limitations, or other channel condition variables, including loading, may also be utilized to determine rates.

The access terminal will also read from a memory, the rate indication, e.g. packet format index, determined from the R-LAB or other rate control indication from the access point, block 204. A comparison is made between the determined rates, block 206. If the rates match, then the rate is utilized for reverse link transmission, block 208.

In the case where the rates do not match, the rate utilized is the rate determined by the access terminal, block 210. In some cases, the access terminal may utilize a rate margin in either its rate calculation, e.g. a more conservative estimate of channel conditions is used for calculating the rate. In addition, in certain cases, an access terminal may only choose a new packet format if the spectral efficiency is sufficiently greater than that allowed by the rate indicated by the access point, e.g. in an R-LAB. These parameters may be set by the system design or vary as statistics related to rate changes, re-transmissions, and packet loss are collected over time.

A message including an indicator of the rate, in the packet being transmitted according to the rate, is utilized for the reverse link transmission, block 212. Additionally, in certain aspects, the packet including the indicator need not be transmitted at the rate, and may be interpreted by the access point as an indicator of future packets to be transmitted at the rate.

In some cases, each packet transmitted at the access terminal determined rate includes the identifier. Alternatively, only one packet, or potentially more than one packet, may include the identifier, while other packets may be flagged to indicate that the rate has changed with the packet ID of the packet with the rate indicator. Further, a packet may be identified, or the system designed, such that after one more packets are transmitted including the rate indication that all future packets transmitted are at the same rate, and decoded as such, at the base station. This may be either for a fixed period or until otherwise altered by the access point or at the access terminal.

FIG. 2B illustrates aspects of an apparatus 250 for communicating reverse link rate indications by an access terminal. Means 252 for determining, at an access terminal, a rate for reverse link transmission is in communication with means 254 for determining whether the rate is different than a rate indicated by an access point for reverse link transmission. Means 254 is in communication with means for, if the rate is different, then transmitting a packet at the rate and indicating in the packet an indicator of the rate.

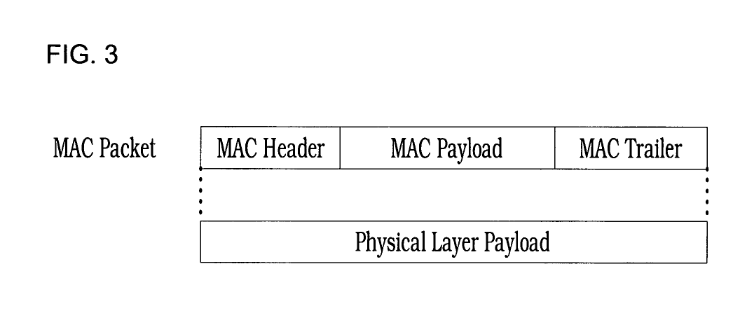

FIG. 3 illustrates aspects of a MAC packet. Generally, a MAC packet includes a MAC header, MAC payload, and MAC trailer. The MAC payload generally includes the data or control information that is being communicated by the access terminal to the access point. The MAC trailer may include error correction or other information.

The MAC header may include various signaling, including packet rate identification when the rate is being specified by the access terminal as different from the assigned rate. Further, the header may also include session information including, one or more of, terminal identifiers, connection layer format messages, indications as to any changes to encryption keys, whether in-band control, e.g. packet rate identifiers are included. Additionally, one or more of the following may be included, if the terminal is identified, session information that indicates the communication parameters for the session, access information, and any other desired parameters.

In certain aspects in-band control may include power control information, e.g. offset from instructed power by the R-LAB; the number of messages buffered for reverse link transmission, quality of service parameters for one or more streams, for the reverse or forward links; and/or rate indications for the transmitted packets.

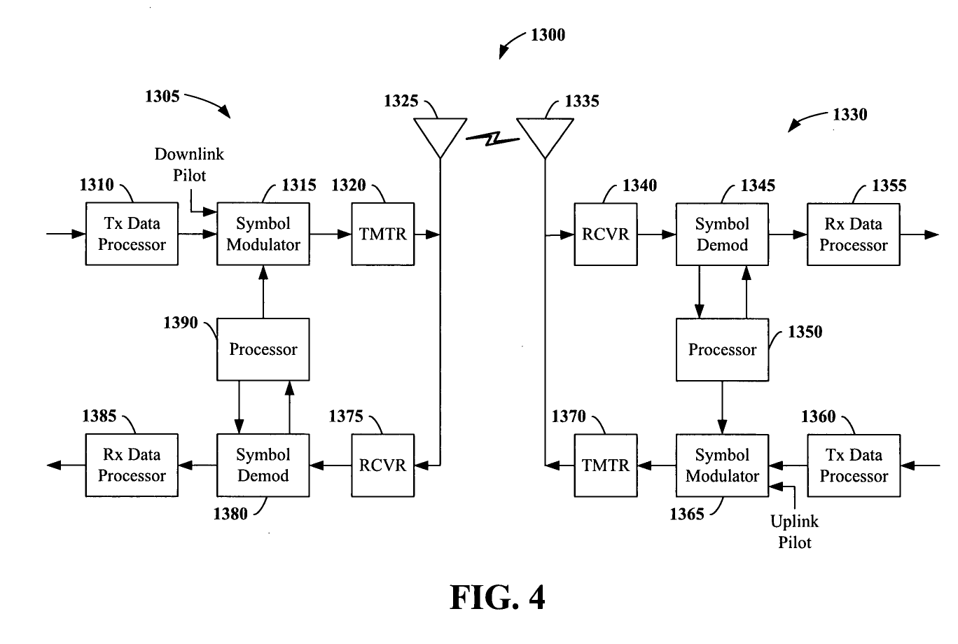

Referring now to FIG. 4, on a forward link transmission, at access point 1305, a transmit (TX) data processor 1310 receives, formats, codes, interleaves, and modulates (or symbol maps) traffic data and provides modulation symbols (“data symbols”). A symbol modulator 1315 receives and processes the data symbols and pilot symbols and provides a stream of symbols. A symbol modulator 1320 multiplexes data and pilot symbols on the proper subcarriers, provides a signal value of zero for each unused subcarrier, and obtains a set of N transmit symbols for the N subcarriers for each symbol period. Each transmit symbol may be a data symbol, a pilot symbol, or a signal value of zero. The pilot symbols may be sent continuously in each symbol period. It will be appreciated that the pilot symbols may be time division multiplexed (TDM), frequency division multiplexed (FDM), orthogonal frequency division multiplexed (OFDM), code division multiplexed (CDM), etc. Symbol modulator 1320 can transform each set of N transmit symbols to the time domain using an N-point IFFT to obtain a “transformed” symbol that contains N time-domain chips. Symbol modulator 1320 typically repeats a portion of each transformed symbol to obtain a corresponding symbol. The repeated portion is known as a cyclic prefix and is used to combat delay spread in the wireless channel.

A transmitter unit (TMTR) 1320 receives and converts the stream of symbols into one or more analog signals and further conditions (e.g., amplifies, filters, and frequency upconverts) the analog signals to generate a forward link signal suitable for transmission over the wireless channel. The forward link signal is then transmitted through an antenna 1325 to the terminals. At terminal 1330, an antenna 1335 receives the forward link signal and provides a received signal to a receiver unit (RCVR) 1340. Receiver unit 1340 conditions (e.g., filters, amplifies, and frequency downconverts) the received signal and digitizes the conditioned signal to obtain samples. A symbol demodulator 1345 removes the cyclic prefix appended to each symbol, transforms each received transformed symbol to the frequency domain using an N-point FFT, obtains N received symbols for the N subcarriers for each symbol period, and provides received pilot symbols to a processor 1350 for channel estimation. Symbol demodulator 1345 further receives a frequency response estimate for the forward link from processor 1350, performs data demodulation on the received data symbols to obtain data symbol estimates (which are estimates of the transmitted data symbols), and provides the data symbol estimates to an RX data processor 1355, which demodulates (e.g., symbol demaps), deinterleaves, and decodes the data symbol estimates to recover the transmitted traffic data. The processing by symbol demodulator 1345 and RX data processor 1355 is complementary to the processing by symbol modulator 1315 and TX data processor 1310, respectively, at access point 1300.

On the reverse link, a TX data processor 1360 processes traffic data and provides data symbols. A symbol modulator 1365 receives and multiplexes the data symbols with pilot symbols, performs modulation, and provides a stream of symbols. The pilot symbols may be transmitted on subcarriers that have been assigned to terminal 1330 for pilot transmission, where the number of pilot subcarriers for the reverse link may be the same or different from the number of pilot subcarriers for the forward link. A transmitter unit 1370 then receives and processes the stream of symbols to generate a reverse link signal, which is transmitted by the antenna 1335 to the access point 1310.

At access point 1310, the reverse link signal from terminal 1330 is received by the antenna 1325 and processed by a receiver unit 1375 to obtain samples. A symbol demodulator 1380 then processes the samples and provides received pilot symbols and data symbol estimates for the reverse link. An RX data processor 1385 processes the data symbol estimates to recover the traffic data transmitted by terminal 1335. A processor 1390 performs channel estimation for each active terminal transmitting on the reverse link.

Processor 1350 may be configured to perform rate selection for reverse link transmission and instruction to include in-band reverse link rate indicators as discussed with respect to FIGS. 1-3.

Processors 1390 and 1350 direct (e.g., control, coordinate, manage, etc.) operation at access point 1310 and terminal 1335, respectively. Respective processors 1390 and 1350 can be associated with memory units (not shown) that store program codes and data. Processors 1390 and 1350 can also perform computations to derive frequency and impulse response estimates for the reverse link and forward link, respectively.

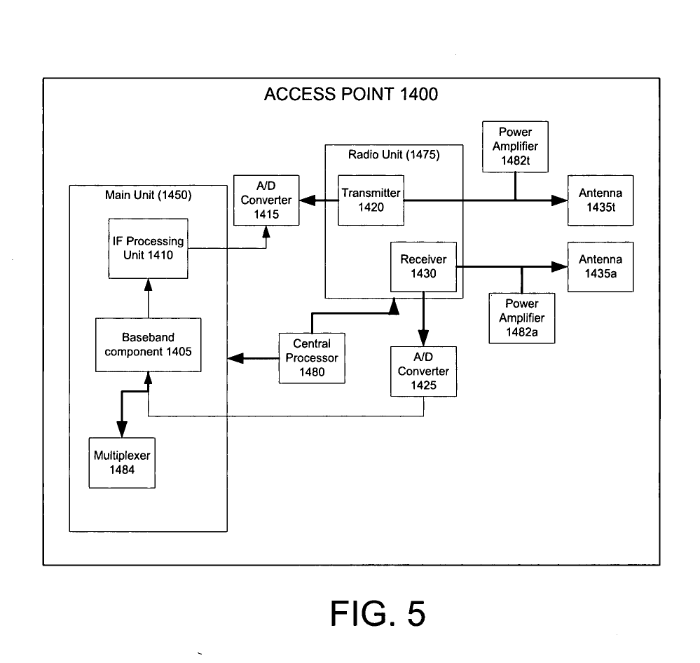

Referring to FIG. 5, an access point can comprise a main unit (MU) 1450 and a radio unit (RU) 1475. MU 1450 includes the digital baseband components of an access point. For example, MU 1450 can include a baseband component 1405 and a digital intermediate frequency (IF) processing unit 1410. Digital IF processing unit 1410 digitally processes radio channel data at an intermediate frequency by performing such functions as filtering, channelizing, modulation, and so forth. RU 1475 includes the analog radio parts of the access point. As used herein, a radio unit is the analog radio parts of an access point or other type of transceiver station with direct or indirect connection to a mobile switching center or corresponding device. A radio unit typically serves a particular sector in a communication system. For example, RU 1475 can include one or more receivers 1430 connected to one more antennas 1435a-t for receiving radio communications from mobile subscriber units. In an aspect, one or more power amplifiers 1482 a-t are coupled to one or more antennas 1435 a-t. Connected to receiver 1430 is an analog-to-digital (A/D) converter 1425. A/D converter 1425 converts the analog radio communications received by receiver 1430 into digital input for transmission to baseband component 1405 via digital IF processing unit 1410. RU 1475 can also include one or more transmitters 120 connected to either the same or different antenna 1435 for transmitting radio communications to access terminals. Connected to transmitter 1420 is a digital-to-analog (D/A) converter 1415. D/A converter 1415 converts the digital communications received from baseband component 1405 via digital IF processing unit 1410 into analog output for transmission to the mobile subscriber units. In some aspects, a multiplexer 1484 for multiplexing of multiple-channel signals and multiplexing of a variety of signals including a voice signal and a data signal. A central processor 1480 is coupled to main unit 1450 and Radio Unit for controlling various processing which includes the processing of voice or data signal.

For a multiple-access system (e.g., a frequency division multiple-access (FDMA) system, an orthogonal frequency division multiple-access (OFDMA) system, a code division multiple-access (CDMA) system, a time division multiple-access (TDMA) system, etc.), multiple terminals may transmit concurrently on the reverse link. For such a system, the pilot subcarriers may be shared among different terminals. The channel estimation techniques may be used in cases where the pilot subcarriers for each terminal span the entire operating band (possibly except for the band edges). Such a pilot subcarrier structure would be desirable to obtain frequency diversity for each terminal. The techniques described herein may be implemented by various means. For example, these techniques may be implemented in hardware, software, or a combination thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors 1390 and 1350.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An access terminal, comprising:
a processor configured to determine a new rate based at least in part upon channel conditions determined at the access terminal, determine whether the new rate is a same as a rate indicated by an access point, and to instruct indication of the new rate being utilized in a packet transmitted to the access point, if the new rate is different from the rate indicated; and
a memory coupled to the processor.

2. The apparatus of claim 1, wherein the processor is configured to determine the new rate by determining a packet format.

3. The apparatus of claim 1, wherein the processor is configured to determine the new rate by determining a spectral efficiency.

4. The access terminal of claim 1, wherein the processor is configure to instruct transmission of the packet with the indication of the new rate, at the new rate.

5. The apparatus of claim 1, wherein the processor is further configured to instruct indication of the new rate in at least one packet transmitted from the access terminal, while transmitting other packets without indication of the new rate at the new rate.

6. The apparatus of claim 1, wherein the indication is transmitted in a header of the packet.

7. The apparatus of claim 1, wherein the processor is further configured to instruct indication of the new rate in each packet transmitted, according to the new rate, from the access terminal.

8. The apparatus of claim 1, wherein the memory comprises a look-up table indicating rates for different channel conditions and the processor is further configured to determine the new rate utilizing the look-up table.

9. The apparatus of claim 1, wherein the packet is a MAC packet.

10. The apparatus of claim 1, wherein the memory is configured to store the rate indicated and the processor is further configured to read from the memory the rate indicated.

11. A method comprising:
determining, at an access terminal, a new rate for reverse link transmission;
determining whether the new rate is different than a rate indicated by an access point for reverse link transmission; and
if the new rate is different, then transmitting a packet indicating in the packet an indicator of the new rate.

12. The method of claim of claim 11, wherein determining the new rate comprises determining a packet format that provides the new rate.

13. The method of claim of claim 11, wherein determining the new rate comprises determining a spectral efficiency to determine the new rate.

14. The method of claim 11, wherein transmitting comprises transmitting the indicator in a header of the packet.

15. The method of claim 14, further comprising modulating the packet according to the new rate.

16. The method of claim 11, wherein transmitting comprises transmitting the indicator in a header of at least one packet and transmitting multiple other packets at the new rate without including the indicator in the multiple packets.

17. The method of claim 11, wherein transmitting comprises transmitting the indicator in a header of each packet transmitted at the new rate.

18. An access terminal comprising:
means for determining a new rate for reverse link transmission;
means for determining whether the new rate is different than a rate indicated by an access point for reverse link transmission; and
means for, if the new rate is different, then transmitting a packet indicating in the packet an indicator of the new rate.

19. The apparatus of claim 17, wherein the means for transmitting comprises means for transmitting the indicator in a header of the packet.

20. The apparatus of claim 19, further comprising means for modulating the packet according to the new rate.

21. The apparatus of claim 17, wherein the means for transmitting comprises means for transmitting the indicator in a header of at least one packet and means for transmitting multiple other packets at the new rate without including the indicator in the multiple other packets.

22. The apparatus of claim 17, wherein the means for transmitting comprises means for transmitting the indicator in a header of each packet transmitted at the new rate.

23. A packet for transmission in a wireless network, including a portion that identifies a rate for transmission that is different than a rate assigned for transmission of the packet.

24. The packet of claim 23, wherein the portion is in a header of the packet.

25. The packet of claim 23, wherein the packet is a MAC packet.

26. The packet of claim 23, wherein the rate comprises a packet format.
